(19) United States
(12) Patent Application Publication
(10) Pub. No.: US 2012/0201964 A1
(43) Pub. Date: Aug. 9, 2012

(54) RESIST COATING DEVICE AND METHOD

(75) Inventors: Weifeng Zhou, Beijing (CN); Jian Guo, Beijing (CN); Xing Ming, Beijing (CN)

(73) Assignee: BEIJING BOE OPTOELECTRONICS TECHNOLOGY CO., LTD., Beijing (CN)

(21) Appl. No.: 13/499,951

(22) PCT Filed: Apr. 19, 2011
(86) PCT No.: PCT/CN11/73010

§ 371 Date: Apr. 3, 2012

(30) Foreign Application Priority Data
Apr. 19, 2010 (CN) 201010154127.0

(51) Int. Cl. B05D 1/26; B05D 3/02; B05C 5/02

(52) U.S. Cl. 427/379; 118/313; 427/427.3; 427/372.2

(57) ABSTRACT

A gumming device and method can reduce or avoid generation of air bubbles between layers thereby improving quality and manufacturing efficiency of TFT LCD. The gumming device comprises a nozzle, a gum feeding mechanism connected with the nozzle and a nozzle moving mechanism. Wherein at least two rows of gum injection holes are included in the nozzle, and the two adjacent rows of gum injection holes are separated by a spacer. The gumming method comprises that the nozzle is moved on the substrate by the nozzle moving mechanism, and each row of gum injection holes in the nozzle is successively opened in a direction opposite to the moving direction of nozzle for applying gum. The gumming device is used for applying multilayer gum.

### TECHNICAL FIELD

The present invention relates to a resist coating device and a resist coating method.

### BACKGROUND

There is a fast improvement in the field of Liquid Crystal Display (LCD) in the past two decades, ranging from the size of displays to performances such as display quality. With continuous efforts, all aspects of LCD have reached the level of conventional cathode ray tube (CRT) displays, with a trend of replacing CRTs with LCDs.

As the manufacturing of LCD continues to advance, the competitions between various manufacturers are getting fiercer. The competitiveness of products is improved due to continuous improvements in the quality of the products as well as lowering of the manufacturing costs.

Multi-domain mask exposure is currently among the developing trends of lithography. The manufacturing capacities can be increased and the costs can be decreased through multi-domain mask exposure. As for now, multi-domain mask exposure may be realized by fabricating a multi-domain region in resist with a broad light sensitive scale.

Currently, two layers of resist are fabricated using the following steps: coat a first layer of a first kind resist, then coat a second layer of a second kind of resist; or, two or more nozzles with a relative large space in-between are used to coat layers of resist successively.

In such case, as the first kind of resist layer has not become solidified when the second kind of resist layer is coated, and in order to avoid the contamination to the second kind of resist by the first kind of resist due to the liquid surface tension, the nozzle of the second kind of resist may not be located within a certain short distance from the first resist layer, thereby causing air bubbles between the two layers, leading to defects in multi-domain mask exposure.

### SUMMARY

An embodiment of the present invention provides a resist coating device and a resist coating method that can reduce or avoid generation of air bubbles between layers.

In order to achieve the above mentioned objectives, an embodiment of the present invention provides a resist coating device, comprising: a nozzle, a resist feeding mechanism connected with the nozzle and a nozzle moving mechanism. At least two rows of resist injection holes are included in the nozzle, and the two adjacent rows of resist injection holes are separated by a spacer.

An embodiment of the present invention also provides a resist coating method, comprising: moving the nozzle on the substrate by the nozzle moving mechanism, and opening each row of resist injection holes in the nozzle successively in a direction opposite to the moving direction of nozzle for applying resist.

### BRIEF DESCRIPTION OF THE DRAWINGS

Following is a description of the drawings being referred to during the description of the embodiment or the current art, in order to better explain the technical solutions in the embodiments of the present invention or of the current art. Apparently, the accompany drawings in the following description are merely samples of the present invention. As to those ordinarily skilled in the art, other drawings may be contemplated based on these accompany drawings without creative works.

FIG. 1 is a schematic drawing of the resist coating device according to the embodiments of the present invention;

FIG. 2 is a schematic drawing of a side view of the nozzle according to the embodiments of the present invention;

FIG. 3 is a schematic drawing of another side view of the nozzle according to the embodiments of the present invention;

FIG. 4 is a schematic drawing of a side view of a multi-layered resist coated by the nozzle according to the embodiments of the present invention;

FIG. 5 is a schematic drawing of a bottom view of the nozzle according to the embodiments of the present invention;

FIG. 6 is a schematic drawing of another bottom view of the nozzle according to the embodiments of the present invention; and

FIG. 7 is a schematic drawing of another side view of the nozzle according to the embodiments of the present invention.

### DETAILED DESCRIPTION OF THE EMBODIMENTS

Following is provided to illustrate the technical solutions of the present invention clearly and completely, in conjunction with the accompany drawings of the embodiments of the present invention. Apparently, the depicted embodiments are merely a portion of the embodiments, rather than all of the embodiments of the present invention. Based on the embodiments of the present invention, those ordinarily skilled in the art can contemplate, without creative works, other embodiments of the present invention, which are within the scope of the present invention.

The resist coating device according to an embodiment of the present invention comprises: a nozzle, a resist feeding mechanism connected with the nozzle and a nozzle moving mechanism; at least two rows of resist injection holes are included in the nozzle, and the two adjacent rows of resist injection holes are separated by a spacer.

A description of the present invention is provided as follows with reference to the resist coating device for applying resists. However, the present invention is not limited to applying photoresist; all those satisfying the conditions of the present inventions are within the scope of the present invention.

As shown in FIG. 1, the resist coating device according to an embodiment of the present invention comprises: a platform 1, a nozzle 2, a resist feeding mechanism connected with the nozzle (not shown) and a nozzle moving mechanism (not shown) moving the nozzle 2. In addition, the substrate 3 for the resist to be applied thereon is placed on the platform 1.

A nozzle 2 of the embodiment of the present invention includes at least two rows of resist injection holes, and the two adjacent rows of resist injection holes are separated by a spacer 4. For example, as shown in FIG. 1, a nozzle 2 includes two rows of resist injection holes, and the two adjacent rows of resist injection holes are separated by a spacer 4. As such, during the movement of the nozzle 2, multilayer resists can be applied by opening each row of resist injection holes successively or in order to apply resist at different timings, thereby coating of resist layers can realized by one movement of single nozzle. After completion of resist coating, lithography is completed with several processes including low pressure drying, baking, exposing, developing, etching etc., to fabricate for example corresponding conductive patterns on array substrates.

In the resist coating device according to the embodiment of the present invention, the nozzle of the device includes at least two rows of resist injection holes, and the two adjacent rows of resist injection holes are separated by a spacer. During resist coating, layers of resist can be applied by opening each row of resist injection holes successively, thereby completing the coating of the resist layers in one movement of single nozzle. As such, it is possible to avoid nozzles for coating of layers of resist, and also further possible to avoid air bubbles occurring between layers due to deviations of locations of the nozzles during resist coating, thereby decreasing the defect ratio of multi-domain mask exposure, improving quality and efficiency of thin film transistor liquid crystal displays (TFT-LCDs).

### First Embodiment of Nozzle

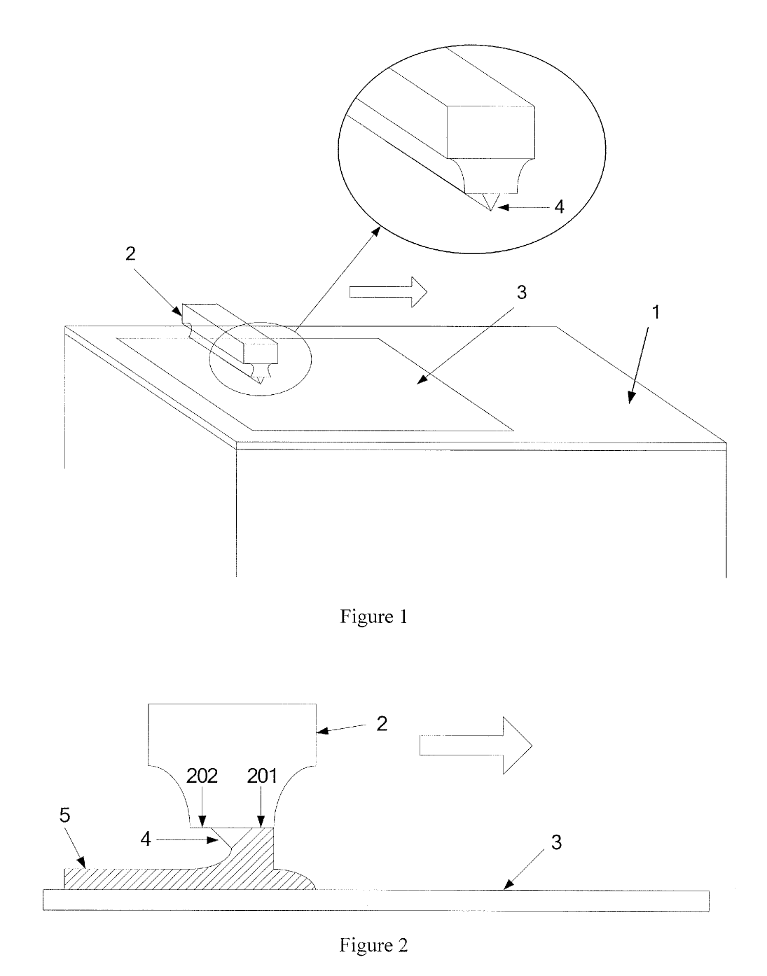

FIG. 2 is a schematic drawing of a side view of the nozzle according to the present invention. In this embodiment, for example, a nozzle 2 includes two rows of resist injection holes 201, 202.

As shown in FIG. 2, the nozzle 2 includes two rows of resist injection holes 201, 202, and the two adjacent rows of resist injection holes are separated by a spacer 4 in a wedge shape. When the nozzle 2 moves in a direction as indicted by the arrow, due to the wedge slope of the wedge spacer 4, a first layer of resist 5 injected by the row of resist injection holes 201 can flow smoothly along the wedge slope of the wedge spacer 4 to adhere to a substrate 3.

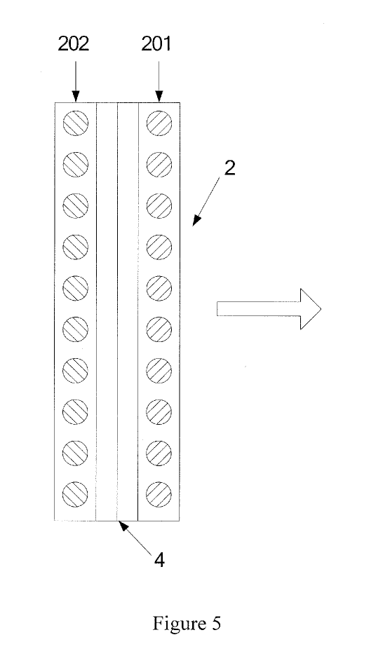

FIG. 5 is a schematic drawing of a bottom view of the nozzle 2 in FIG. 2. It can be clearly seen from FIG. 5 that, the nozzle 2 includes two rows of resist injection holes 201, 202; each row of the resist injection holes comprises resist injection holes arranged in a row transverse to the moving direction of nozzle 2 (the arrow direction). Two adjacent rows of resist injection holes are separated by the wedge spacer 4.

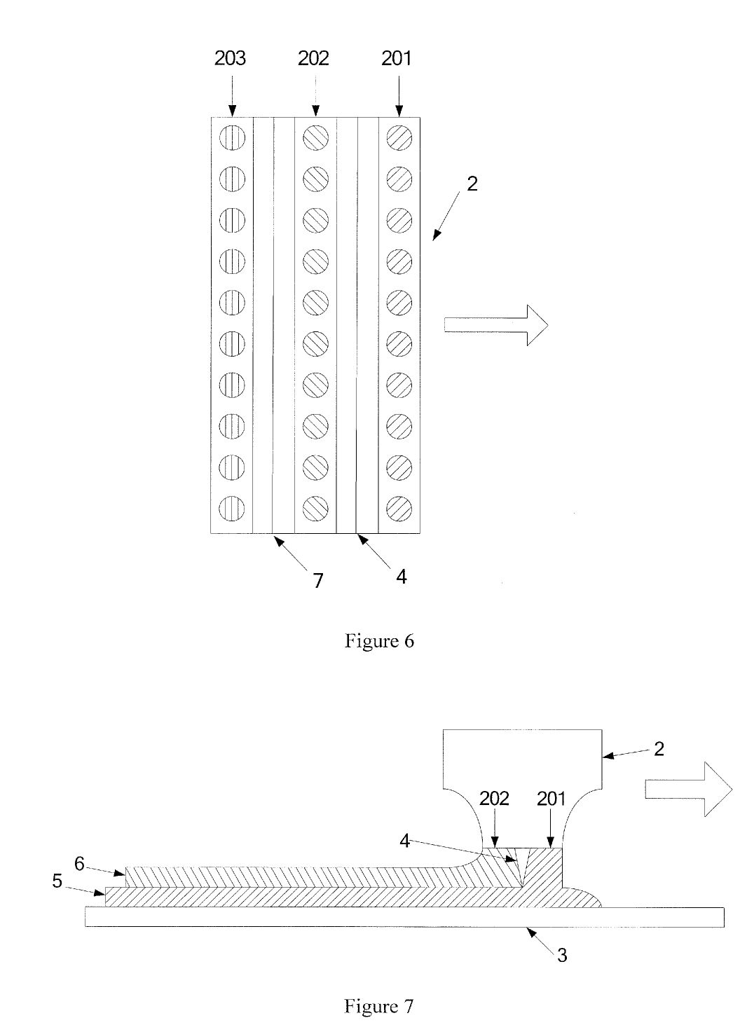

Furthermore, when there are a plurality of rows of resist injection holes in nozzle 2, for example, three rows of resist injection holes 201, 202, 203 as shown in FIG. 6, similarly each row of the resist injection holes comprises resist injection holes arranged in a row transverse to the moving direction of nozzle 2 (the arrow direction), two adjacent rows of resist injection holes 201 and 202 are separated by a wedge spacer 4, and the rows of resist injection holes 202 and 203 are separated by a wedge spacer 7. In case of more rows of resist injection holes, they are also arranged in such manner.

One preferred configuration is that, as shown in FIG. 7, the wedge spacer 4 is relatively long, with the top end of the extension portion being in right contact with the top surface of the resist 5 applied by the first row of resist injection holes 201 during resist coating. A more preferable layered structure between layers of resist can be maintained by using such a wedge spacer, and the top end of this wedge spacer 4 can level off the prior layer before coating the next layer of resist during the movement.

In other embodiment of the present invention, the shape of the spacer disposed between the two rows of injection holes are not limited to a wedge shape, other shapes such as a hemispherical shape, a trapezoid shape or like, or a combination of these above can be employed; furthermore, in case of the cross section of the spacer in a wedge shape, the sides of the wedge may be curved, such as an inward concave or an outward convex. In addition, the spacer may be replaceable, such that differently shaped (such as cross sections, heights and etc.) spacers can be used for different kinds of resist.

The description of the resist coating method utilizing the resist coating device according to the embodiments of the present invention is provided as follows. The embodiment of the method comprises:

S801: Place a substrate on the platform, adjust the distance between the substrate and the nozzle to a proper value. For example, a top end of the extension portion of the spacer between two rows of resist injection holes is in right contact with the top surface of the resist to be coated below it during resist coating.

S802: the nozzle is moved on the substrate by a nozzle moving mechanism, and each row of resist injection holes in the nozzle is successively opened in a direction opposite to the moving direction of nozzle for applying resist. The moving velocity of the nozzle may be decided according to the factors such as type, characteristics, and so on of the resist to be applied.

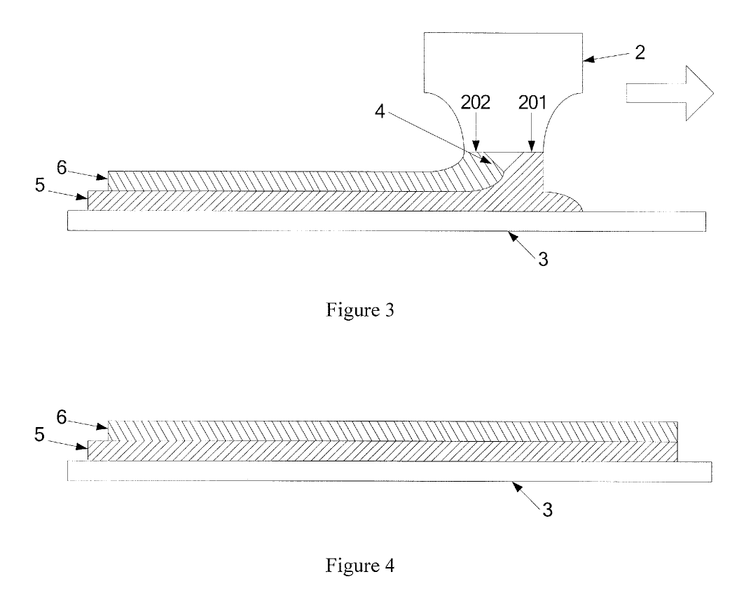

In particular, when two rows of resist injection holes are used to coat two layers of resist for example, as shown in FIG. 2, the first row of resist injection holes 201 on the left side of the nozzle 2 is opened first during resist coating, to fabricate a resist coating start region with a length of 1-5 mm (i.e., a predetermined length) of the first layer of resist 5 on the edge of the substrate 3, and after lasting of 5-30 seconds (a predetermined time period) a compact protection film is formed in the top surface of the resist coating start region of the first layer of resist 5 due to volatilization of the solution. As shown in FIG. 3, the second row of resist injection holes 202 is then opened to inject the second layer of resist 6, due to the compactness of the top surface of the first layer of resist 5, an obvious delamination of the first layer of resist 5 and the second layer of resist 6 occurs in the resist coating start region, the nozzle 2 is then moved from one side of the substrate 3 till the other side, thereby coating two relatively obvious layers of resist under the guiding of the delamination in the resist coating start region. In case of more than two rows of resist injection holes included in the nozzle 2, the above steps are repeated till each row of the resist injection holes is opened for resist coating.

S803: Upon completion of resist coating, the first and the second row of resist injection holes 201,202 are closed. Two layers of resist are achieved as shown in FIG. 4, with few or substantially no air bubbles between the layers.

Here the two rows of injection holes may be closed at the same time, or the first row of resist injection holes may be closed first, followed by the close of the second row of resist injection holes.

S804: The substrate undergoes a low pressure drying process during the first predetermined time period after completion of resist coating.

Due to the liquid fluidity of resist, the two layers of resist as fabricated may interdiffuse into each other over time, thereby the coated substrate must be sent to next step within a short time period. For example, the inventors found that the resist with a viscosity of 8-10 CP may stay in the delamination state of two layers within 20 seconds (i.e., the first predetermined time period), thus the low pressure drying must be conducted within 20 seconds to remove most solution in the resist, thereby solidifying the resist. For resist with lower viscosities, the corresponding time period may be relatively shorter. In contrast, for resists with higher viscosities, the corresponding time period may be relatively longer.

S805: The substrate is pre-baked during the second predetermined time period after the completion of the low pressure drying.

Similarly, the inventors found that within 60 seconds (i.e., the second predetermined time period), the interdiffusions between different layers of resist may be prevented by a pre-bake process to remove the remaining water and solution within the resist, thereby solidifying the resist thoroughly to form a stable layered structure of the two layers of resist.

The lithography is conducted after steps including exposing, developing, etching, etc.

In the present embodiment, a multi-domain gray-scaled resist topography can be easily formed due to the different properties of the two kinds of resist. In addition, if a kind of resist with relative better adhesion to the glass substrate is selected for the bottom layer, the etching retraction amount of the resist can be effectively decreased, thereby improving the wiring capacity.

It should be noted that the present embodiment is described with reference to two layers of resist, but coating, low pressure drying and pre-baking for a plurality of layers of resist are similar to those of the above embodiment, the plurality of layers of resists are formed by coating at different timings followed by low pressure drying and pre-baking within a short time period.

In the resist coating device and method according to the present invention, rows of resist injection holes are included in a nozzle, and the two adjacent rows of resist injection holes are separated by a spacer. During resist coating, layers of resist can be applied by opening each row of resist injection holes successively or in order, thereby completing the resist coating by one movement of single nozzle. As such, it is possible to avoid nozzles for resist coating of resist layers, and also possible to avoid air bubbles between layers due to deviations of locations of the nozzles during resist coating, thereby decreasing the defect ratio of multi-domain mask exposure, improving quality and efficiency of TFT-LCDs.

The embodiment of the processes provided above is merely the preferred embodiments to carry out the invention, not the only one implementation of the present invention. Different materials, processing parameters and equipments may be used depending on the requirements of different manufacturing lines.

Above are merely specific embodiments of the present invention; however, they are not intended to limit the scope of the present invention in any manner. Those ordinary skilled in the art may easily recognize various modifications or alternations within the scope of the present invention being disclosed. Thus, the scope of the present invention shall be determined in the appended claims.

What is claimed is:

1. A resist coating device, comprising:
a nozzle;
a resist feeding device connected with the nozzle; and
a nozzle moving mechanism,
wherein at least two rows of resists injection holes are included in the nozzle, and the two adjacent rows of resist injection holes are separated by a spacer.

2. The device according to claim 1, wherein each row of the resist injection holes comprises resist injection holes arranged in a row transverse to the moving direction of the nozzle.

3. The device according to claim 1, wherein the spacer is a spacer in a wedge shape.

4. The device according to claim 1, wherein the spacer is replaceable.

5. A resist coating method, comprising:
moving a nozzle on a substrate by a nozzle moving mechanism, and opening each row of resist injection holes in the nozzle successively in a direction opposite to the moving direction of the nozzle for resist application;
wherein at least two rows of resists injection holes are included in the nozzle, and the two adjacent rows of resist injection holes are separated by a spacer.

6. The method according to claim 5, wherein opening each row of the resist injection holes in the nozzle successively in the direction opposite to the moving direction of the nozzle for resist application comprises:
in a direction opposite to the moving direction of the nozzle, opening the first row of resist injection holes first during resist coating to form a resist coating start region of a first layer of resist with a predetermined length on an edge of the substrate, and after a predetermined time period, then opening a second row of resist injection holes adjacent to the first row of resist injection holes.

7. The method according to claim 5, wherein the second row of resist injection holes is opened to form a second resist coating start region with a predetermined length, and after for a second predetermined time, the operations of the second row of resist injection holes is repeated till each of the remaining rows of resist injection holes is opened, then resist is applied.

8. The method according to claim 5, further comprising:
conducting a low pressure drying on the said substrate after completion of the resist application.

9. A method according to claim 8, further comprising:
conducting a pre-baking on the said substrate after completion of the lower pressure drying.

10. The method according to claim 5, wherein moving the nozzle moved on the substrate by the nozzle moving mechanism comprises:
moving the nozzle by the nozzle moving mechanism from one side of the substrate till the other side.

11. The method according to claim 5, wherein the spacer is a space in a wedge shape.

12. The method according to claim 11, wherein a top end of an extension portion of the spacer in a wedge shape contacts a top surface of the resist applied below.
